(19) United States
(12) Patent Application Publication
(10) Pub. No.: US 2022/0299015 A1
(43) Pub. Date: Sep. 22, 2022

(54) Bottom-Founded Ocean Thermal Energy Conversion Plant

(71) Applicant: The Abell Foundation, Inc., Baltimore, MD (US)

(72) Inventors: Barry R. Cole, Mineral, VA (US); Laurence Jay Shapiro, Fair Lawn, NJ (US); Jonathan M. Ross, Arnold, MD (US); William Martin Hayden, Houston, TX (US)

(21) Appl. No.: 17/631,068

(22) PCT Filed: Jul. 31, 2020
(86) PCT No.: PCT/US20/44585

§ 371 Date: Jan. 28, 2022

Related U.S. Application Data
(60) Provisional application No. 62/880,803, filed on Jul. 31, 2019.

(51) Int. Cl. F03G 7/05; F03G 7/00

(52) U.S. Cl. CPC F03G 7/05; F03G 7/027

(57) ABSTRACT

Ocean thermal energy conversion plants can include: an operations center located onshore; a bottom-founded structure located offshore, the bottom-founded structure containing plant evaporators and plant condensers; and control cables extending between the operations center and plant machinery in the bottom-founded structure. Methods of providing electricity can include: transmitting signals from an operations center located onshore to an unmanned structure located offshore; and operating evaporators, condensers, and pumps located in the unmanned structure in response to the signals to generate between 0.5 megawatts and 15 megawatts of electricity in the unmanned structure.

### CROSS REFERENCE TO RELATED APPLICATIONS

This application claims the benefit of priority under 35 U.S.C. Section 119(e) to U.S. Provisional Patent Application No. 62/880,803, filed on Jul. 31, 2019, the contents of which are hereby incorporated by reference in their entirety.

### TECHNICAL FIELD

This disclosure relates to ocean thermal energy conversion power plants and more specifically to bottom-founded ocean thermal energy conversion power plants.

### BACKGROUND

Ocean Thermal Energy Conversion (“OTEC”) is a manner of producing renewable energy using solar energy stored as heat in the oceans' tropical regions. Tropical oceans and seas around the world offer a unique renewable energy resource. In many tropical areas (between approximately 20° north and 20° south latitude), the temperature of the surface sea water remains nearly constant. To depths of approximately 100 ft the average surface temperature of the sea water varies seasonally between 75° and 85° F. or more. In the same regions, deep ocean water (between 2500 ft and 4200 ft or more) remains a fairly constant 40° F. Thus, the tropical ocean structure offers a large warm water reservoir at the surface and a large cold water reservoir at depth, with a temperature difference between the warm and cold reservoirs of between 35° to 45° F. This temperature difference remains fairly constant throughout the day and night, with small seasonal changes.

The OTEC process uses the temperature difference between surface and deep sea tropical waters to drive a heat engine to produce electrical energy. OTEC power generation was identified in the late 1970's as a possible renewable energy source having a low to zero carbon footprint for the energy produced. An OTEC power plant, however, has a low thermodynamic efficiency compared to more traditional, high pressure, high temperature power generation plants. For example, using the average ocean surface temperatures between 80° and 85° F. and a constant deep water temperature of 40° F., the maximum ideal Carnot efficiency of an OTEC power plant will be 7.5 to 8%. In practical operation, the gross power efficiency of an OTEC power system has been estimated to be about half the Carnot limit, or approximately 3.5 to 4.0%. Additionally, analysis performed by leading investigators in the 1970's and 1980's, and documented in “Renewable Energy from the Ocean, a Guide to OTEC” William Avery and Chih Wu, Oxford University Press, 1994 (incorporated herein by reference), indicates that between one quarter to one half (or more) of the gross electrical power generated by an OTEC plant operating with a ΔT of 40° F. would be required to run the water and working fluid pumps and to supply power to other auxiliary needs of the plant. On this basis, the low overall net efficiency of an OTEC power plant converting the thermal energy stored in the ocean surface waters to net electric energy has not been a commercially viable energy production option.

An additional factor resulting in further reductions in overall thermodynamic efficiency is the loss associated with providing necessary controls on the turbine for precise frequency regulation. This introduces pressure losses in the turbine cycle that limit the work that can be extracted from the warm sea water.

This low OTEC net efficiency compared with efficiencies typical of heat engines that operate at high temperatures and pressures has led to the widely held assumption by energy planners that OTEC power is too costly to compete with more traditional methods of power production.

Indeed, the parasitic electrical power requirements are particularly important in an OTEC power plant because of the relatively small temperature difference between the hot and cold water. To achieve maximum heat transfer between the warm sea water and the working fluid, and between the cold sea water and the working fluid large heat exchange surface areas are required, along with high fluid velocities. Increasing any one of these factors can significantly increase the parasitic load on the OTEC plant, thereby decreasing net efficiency. An efficient heat transfer system that maximizes the energy transfer in the limited temperature differential between the sea water and the working fluid would increase the commercial viability of an OTEC power plant.

In addition to the relatively low efficiencies with seemingly inherent large parasitic loads, the operating environment of OTEC plants presents design and operating challenges that also decrease the commercial viability of such operations. As previously mentioned, the warm water needed for the OTEC heat engine is found at the surface of the ocean, to a depth of 100 ft or less. The constant source of cold water for cooling the OTEC engine is found at a depth of between 2700 ft and 4200 ft or more. Such depths are not typically found in close proximity to population centers or even land masses. An offshore power plant is required.

Environmental concerns associated with an OTEC plant have also been an impediment to OTEC operations. Traditional OTEC systems draw in large volumes of nutrient rich cold water from the ocean depths and discharge this water at or near the surface. Such discharge can effect, in a positive or adverse manner, the ocean environment near the OTEC plant, impacting fish stocks and reef systems that may be down current from the OTEC discharge.

### SUMMARY

Aspects of the present disclosure are directed to bottom-founded power generation plant utilizing OTEC processes, e.g., OTEC plants including: an operations center located onshore; a bottom-founded structure located offshore, the bottom-founded structure containing plant evaporators and plant condensers; and a control system extending between the operations center and plant machinery in the bottom-founded structure. Embodiments can include one or more of the following features.

In some embodiments, OTEC plants include a primary seawater pipe extending from the bottom-founded structure to a depth of at least 1500 feet, the primary seawater pipe disposed on or constrained slightly above the seabed.

In some embodiments, OTEC plants include power transmission lines extending from the bottom-founded structure across a shoreline, the transmission lines configured to transmit between 10 kilovolts and 35 kilovolts of electricity.

In some embodiments, OTEC plants include waterlines extending onshore from the bottom-founded structure.

In some embodiments, the control system comprises control cables extending between the operations center and the bottom-founded structure.

In some embodiments, the primary control system is located on the bottom-founded structure connected to the utility company's supervisory control and data acquisition (SCADA) system on shore via control cables between the operations center and the bottom-founded structure.

In some embodiments, the plant evaporators and the plant condensers are located below the waterline of the bottom-founded structure.

In some embodiments, the plant evaporators and the plant condensers are located slightly (2 feet to 4 feet) above the waterline of the bottom-founded structure.

In some embodiments, the bottom-founded structure extends less than 30 feet above the waterline.

In some embodiments, the bottom-founded structure has a vertical height measured from the seabed to a highest overhead and highest overhead of the bottom-founded structure extends above the waterline less than 20% of the vertical height of the bottom-founded structure.

In some embodiments, the bottom-founded structure has a vertical height measured from the seabed to a highest overhead and the highest overhead of the bottom-founded structure extends above the waterline less than 40% of the vertical height of the bottom-founded structure.

In some embodiments, the bottom-founded structure is placed at a location within water depth of between 45 and 250 feet (e.g., less than 200 feet, less than 150 feet, greater than 80 feet, or greater than 100 feet) measured at the centerline of structure.

In some embodiments, OTEC plants include the bottom-founded structure that is placed at a location where the distance between the shoreline and shelf break is between 150 yards and 6600 yards. In some cases, the bottom-founded structure is placed at a location where the seabed offshore of the shelf break descends to a depth of at least 1500 feet within 300 yards of the shoreline.

In some aspects, methods of providing electricity include: transmitting signals from an operations center located onshore to an unmanned structure located offshore; and operating evaporators, condensers, and pumps located in the unmanned structure in response to the signals to generate between 0.5 megawatts and 15 megawatts net of electricity in the unmanned structure. Embodiments can include one or more of the following features.

In some aspects, methods of providing electricity include: transmitting signals from an operations center located onshore to a manned structure located offshore; and operating evaporators, condensers, and pumps located in the unmanned structure in response to the signals to generate between 0.5 megawatts and 15 megawatts net of electricity in the manned structure. Embodiments can include one or more of the following features.

In some embodiments, methods include pumping seawater from a depth of at least 1500 feet to the unmanned structure.

In some embodiments, methods include transmitting electricity onshore from the unmanned structure.

In some embodiments, methods include pumping water onshore from the unmanned structure.

In some embodiments, transmitting signals comprises transmitting signals from the operations center on shore to the unmanned structure offshore through control cables extending between the operations center and the bottom-founded structure.

In some aspects, methods of providing electricity include: transmitting signals between a utility operations control center located onshore and the manned operations control center located on the bottom-founded structure located offshore; and operating evaporators, condensers, and pumps located in the manned structure in response to the signals from the utility company operations control center to generate between 0.5 megawatts and 15 megawatts of electricity in the manned structure. Embodiments can include one or more of the following features.

In some embodiments, methods include pumping seawater from a depth of at least 1500 feet to the manned structure.

In some embodiments, methods include transmitting electricity onshore from the manned structure.

In some embodiments, methods include pumping water onshore from the manned structure.

In some embodiments, transmitting signals comprises transmitting signals from the operations center on shore to the manned structure offshore through control cables extending between the operations center and the bottom-founded structure.

In some embodiments, transmitting signals comprises transmitting signals from the operations center on shore to the manned structure offshore through control cables extending between the operations center and the bottom-founded structure.

Bottom-founded OTEC plants can be implemented combining an onshore operations center and onshore switchyard/interconnection to electric grid with an unmanned offshore plant housing equipment such evaporators, condensers, pumps, and generators. The operations center is often co-located with the switchyard/interconnection to electric grid. The unmanned offshore plant is designed to reduce maintenance requirements by making the existing offshore plant equipment as maintenance free as possible. This will likely result in more robust monitoring, command, and control systems as well as simpler but higher reliability equipment, and will result in a higher capital cost but lower maintenance and labor cost.

For example, marine coating systems can be applied throughout. Vibration sensors can be installed on all rotating machinery to enable condition-based rather than scheduled maintenance. Automatic backflush seawater strainers between the seawater pumps and heat exchanger enclosures entrap and remove debris that could clog, foul and reduce performance of the heat exchangers. Seawater and ammonia piping cross-overs with isolation valves enable the power plant to continuously operate near full output capacity even if one pump, heat exchanger enclosure or ammonia turbine-generator needs to be shut down for maintenance. To reduce corrosion, the exterior structure of the flat-sided structure, namely the boat landing platform and accommodation ladder, life boat davits, handrails and stairs to the weather deck and lighting fixtures, are made of non-corrosive materials. The seawater pumps and strainer bodies can be made of austenitic stainless steel. The work area may be entirely enclosed and air conditioned, so only low maintenance, water-tight enclosed lights required by International Maritime Organization convention are installed on the exterior of the structure. Doors and hatches exposed to sun and waves exposure may be limited to two cargo doors on opposite sides of the Main Deck and the door(s) to the boat landing. All cargo doors open outward so that if the ocean rises due to storm surge and waves strike the closed doors, the seal compresses and no water enters the interior of the structure.

In addition, high-reliability items (e.g., seawater strainers, seawater pumps, ammonia pumps, HVAC fans and cooling coils, start-up and emergency diesel generators, LED and fiber-optic lighting, variable frequency drives and motors, fire pumps, water-tight doors and hatches, instruments and gauges, alarm and control systems) can be built into the offshore structure and lower-reliability, higher maintenance items (e.g., step-up transformers and storage batteries) installed onshore in the interconnection facility.

Systems in the manned offshore plant will typically be controlled on the structure during normal conditions but may be controlled from the onshore operations center under abnormal conditions allowing the plant to continue to operate when other generating systems on shore need to be shut down, thereby providing power to shore during emergency situations. Systems in the unmanned offshore plant will be controlled at the onshore operations center under normal and emergency conditions. The unmanned configuration can reduce operations costs as personnel seldom have to go across water to plant. The manned configuration can reduce operations costs as personnel can be accommodated for extended periods of time and perform routine operations and maintenance between shift changes.

Bottom-founded OTEC plants can be implemented with most or all plant machinery located below the waterline. This configuration can reduce the structure-borne and air-borne noise emission associated with some OTEC plants. The placement of pumps below sea-level in the OTEC plants reduces parasitic pumping power thereby making more power available to transmit to shore.

Low requirements for topside space allow bottom-founded OTEC plants to be configured with most of structure also located below the waterline reducing the visual impact of the plant. This feature can be particularly important in locations such as, for example, remote resorts sited to take advantage of natural beauty. The low profile above the ocean surface in turn lowers the height of safety lights and communication antennas, and thus reduces potential impacts on aircraft operations while providing near-shore aids to navigation for fishermen and pleasure boaters.

Some plants are constructed on shore with part of the structure below the waterline and is sealed against storm surge and storm waves. These plants can be bottom-founded plants that are moved to an artificial cove, the bottom of which is level with the adjacent sea floor, and the entrance of which might be closed with a protective breakwater. These plants can be sited so that they can be refloated and removed, to be replaced by an upgraded version after the useful life is reached.

In bottom-founded OTEC plants, stresses on seawater pipe connections are reduced relative to floating OTEC plants. The connections on bottom-founded OTEC plants can be fixed and simply flanged rather than configured to compensate for the motion of both a floating plant and pipes suspended from the floating plant in the water column and resultant forces.

As used herein, the term “bottom-founded” includes structures which are fixed to the sea bottom.

The details of one or more embodiments are set forth in the accompanying drawings and the description below. Other aspects, features, and advantages of the disclosure will be apparent from the description and drawings, and from the claims.

### DESCRIPTION OF DRAWINGS

FIG. 1 is a plan view schematic of an exemplary bottom-founded OTEC plant.

FIG. 2 is a side view schematic of the offshore portion of the bottom-founded OTEC plant of FIG. 1.

FIG. 3 is a plan view of an evaporator deck of the bottom-founded OTEC plant of FIG. 1.

FIG. 4 is a plan view of a condenser deck of the bottom-founded OTEC plant of FIG. 1.

FIG. 5 is a schematic of an aerial view of a second exemplary bottom-founded OTEC plant.

FIG. 6 is a side view schematic of the bottom-founded OTEC plant of FIG. 5.

FIG. 7 is a side view schematic of the bottom-founded structure portion of the OTEC plant of FIG. 5.

FIG. 8 is a plan view of a first deck of the bottom-founded OTEC plant of FIG. 5.

FIG. 9A is a schematic of a heat exchanger of the bottom-founded OTEC plant of FIG. 5 with a rack of heat exchanger arrays removed.

FIG. 9B is a schematic of a rack of heat exchanger arrays of the heat exchanger of FIG. 9A.

FIG. 10 is a plan view of control and accommodation spaces of the first deck of FIG. 8.

FIG. 11 is a plan view of a second deck of the bottom-founded OTEC plant of FIG. 5.

FIG. 12 is a schematic of a view from shore of the bottom-founded OTEC plant of FIG. 5.

### DETAILED DESCRIPTION

Bottom-founded OTEC plants can provide a highly survivable platform for the near-shore environment. Such plants are particularly well-suited for locations with a shallow, narrow shelf and a rapidly plunging seawall to depth for cold water. Such locations include, for example, numerous sites in the Caribbean Sea, Pacific Ocean and Indian Ocean. The high survivability of bottom-founded structures also makes them particularly well-suited for locations that are subject to severe storms.

There are many island communities in the tropics that could benefit from the base-load electricity generated by an OTEC power plant. Many of these islands have small populations of permanent residents and/or visitors with low total power demand of 1.5 MW to 5.0 MW. For example, several of the “family islands” in The Bahamas have permanent resident populations around 2,000 to 6,000 people with 1.5 MW to 10.0 MW peak electricity demand. This demand can be served by an OTEC plant but is too small to justify the capital costs of the large offshore platform with its supporting infrastructure of spar-based OTEC plants.

A bottom-founded OTEC plant can reduce the costs and reef damage associated with shore-based OTEC plants. Bottom-founded OTEC plants do not require the installation across the reef and shoreline of the warm seawater and cold seawater intake and return pipes associated with shore-based OTEC plants. Such pipes increase capital costs and, in some instances, reef damage of shore-based OTEC plants. Bottom-founded OTEC plants also do not require the multiple anchor sites and chains sweeping across the reef associated with floating OTEC plants moored near the shore. Moreover, bottom-founded OTEC plants can be placed in locations which lack the shelf large enough to anchor an eight-point mooring spread for an OTEC barge.

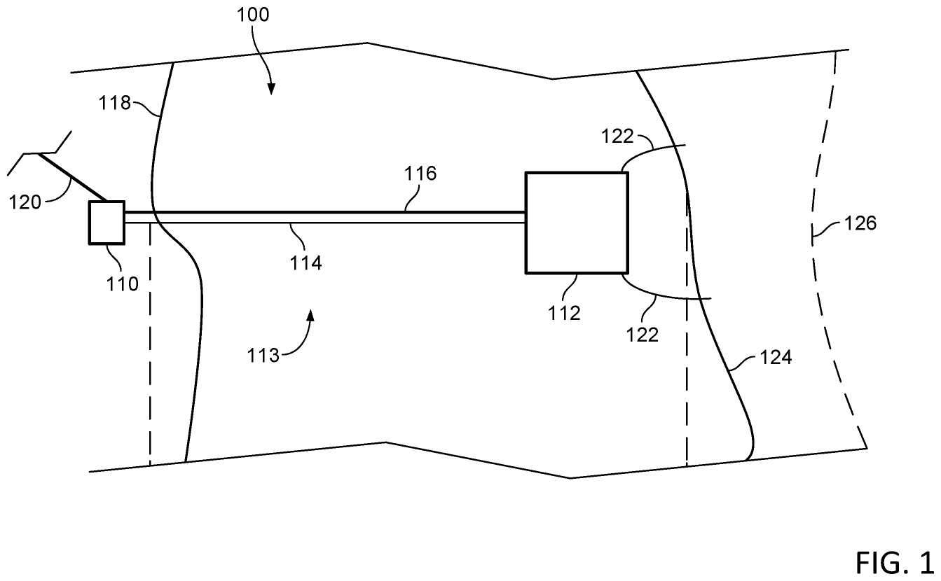

Referring to FIG. 1, an exemplary bottom-founded OTEC plant 100 includes an operations center 110 located onshore, a bottom-founded structure 112 located offshore, and a control system 113 extending between the operations center 110 and the bottom-founded structure 112. The bottom-founded structure 112 contains plant evaporators and condensers, pumps (e.g., warm water and cold water pumps), and turbine generators driven by a working fluid heated and cooled by the evaporators and condensers, respectively.

The control system 113 of the OTEC 100 includes control stations in the operations center 110, control cables 114 extending between the operations center 110 and the bottom-founded structure 112, and remote actuators in the bottom-founded structure 112 operable to control machinery in the bottom-founded structure 112. Some OTEC plants can be implemented with other approaches to remotely operating machinery in the bottom-founded structure 112. For example, some OTEC plants use radiofrequency transmission of control signals from the operations center 110 to the bottom-founded structure 112 instead of or in addition to transmission of the control signals through the control cables 114.

The exemplary OTEC plant 100 also includes transmission lines 116 extending from the bottom-founded structure across the shoreline 118. The transmission lines 116 are configured to transmit between 10 kilovolts and 33 kilovolts of electricity. In some OTEC plants, the operations center is often co-located with the switchyard/interconnection to electric grid 120 and the transmission lines 116 extend between the bottom-founded structure 112 and the operations center 110. Operations such as, for example, power conditioning can be performed at the onshore switchyard. In some OTEC plants, the transmission lines 116 go to a separate switchyard/interconnection to the electric grid rather than extending to the operations center 110.

Both the transmission lines 116 and control cables 114 are laid on the sea floor and lightly covered with riprap or special protective pads in the illustrated OTEC plant 100. This approach is anticipated to protect the control cables 114 and transmission lines 116 while also limiting damage to the seabed and reef.

In the illustrated OTEC plant 100, a single operations center 110 controls a single bottom-founded structure 112. In some systems, a single operations center 110 is connected to and controls multiple bottom-founded structures 112. Similarly, some systems are implemented with one or more backup operation centers 110 to provide redundancy.

Primary seawater pipes 122 extend from the bottom-founded structure 112 over the shelf break 124 to a depth of at least 1500 feet. The primary seawater pipes 122 are disposed on the seabed. In the exemplary OTEC plant 100, the primary seawater pipe 122 used for intake is separate from the primary seawater pipe 122 used for discharge. In some OTEC plants, the intake and discharge primary seawater pipes 122 are separate pipes that are co-located. In some OTEC plants, cold water intake and discharge are provided by a single pipe with at least two separate flow channels.

Bottom-founded OTEC plants are well-suited for locations with a shallow, narrow shelf and a rapidly plunging seawall to depth for cold water. Locations where the distance D1 between the shoreline 118 and the shelf break 124 is between 150 yards and 6600 yards are appropriate for placement of the bottom-founded structure 112. The bottom-founded structure 112 is placed close to the shelf break 124 at a point where the seabed offshore of the shelf break descends to a depth of at least 1500 feet within a distance of at most 15 miles of the shoreline. The bottom-founded structure 112 is set back from the shelf break at least 80 yards to avoid fracturing the sea floor strata near the shelf break. For example, the distance D2 between the shoreline and the 1500 foot bottom contour 126 is 600 yards and the distance D3 between the bottom-founded structure 112 and the shelf break is 200 yards at one site considered for a bottom-founded OTEC plant.

The bottom-founded structure 112 can be constructed as a steel structure set on a steel or concrete crib set and pinned to the seafloor. The structure would consist of the crib and two steel decks that would rise about sixty feet above the sea floor and be partially or completely submerged. A double-walled steel service trunk rising above the ocean surface allows periodic inspection and maintenance and equipment removal when necessary. The crib and foundation can be formed of high strength, pre-cast concrete constructed on shore, floated to location, and set on bottom. Alternatively, the crib can be pre-fabricated of steel, and welded or bolted to the bottom of the structure, that is filled with concrete pumped from the surface after the crib is positioned and set on the sea floor.

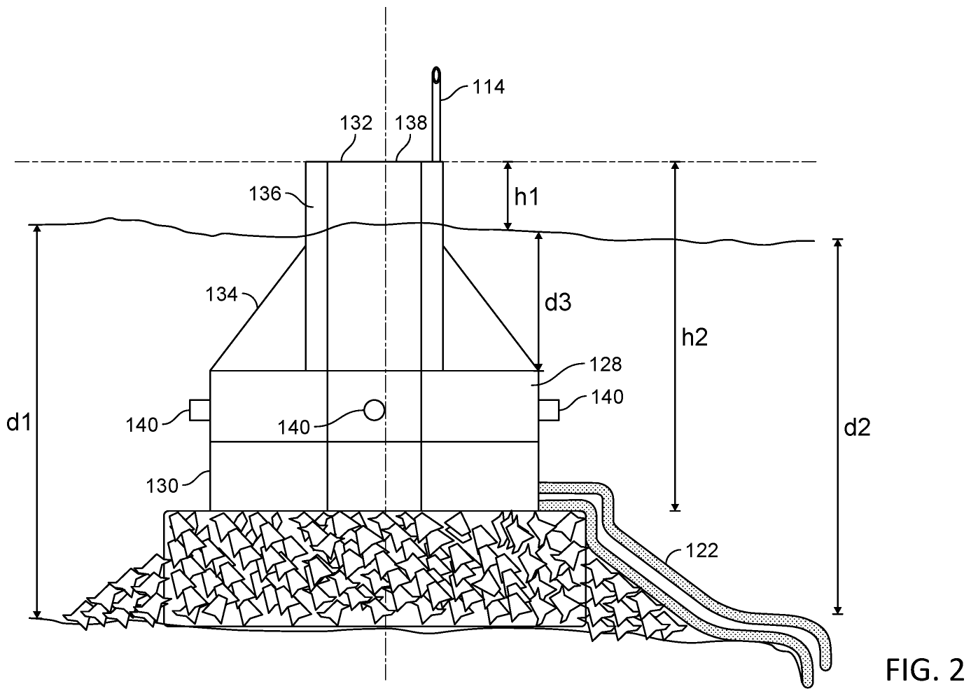

Referring to FIGS. 2-4, the exemplary bottom-founded structure 112 includes an evaporator deck 128 and a condenser deck 130 formed around an access trunk 132 with a large center well. Buttress brackets 134 stiffen the access trunk 132 against moment forces from wave strikes. A concentric pipe structure 136 can provide double wall protection of access trunk 132. The highest deck of the bottom-founded structure 112 is an upper deck 138 with a large watertight hatch sealing the access trunk 132. The double-walled steel service access trunk 132 rises a height h1 above the sea surface under calm conditions at mean high tide. The height h1 can be between 12 and 30 feet. The height h1 that highest overhead of the bottom-founded structure 112 extends above the waterline is generally less than 20% of the overall vertical height h2 measured from the seabed to a highest overhead of the bottom-founded structure.

A navigation signal 144 (e.g., light and/or sound signal) can be attached to the top of the access trunk 132. Since only the trunk access rises above the sea surface, the bottom-founded structure has a low visual impact. The bottom-founded structure can also be sited to serve also as navigation aids for mariners and aircraft.

The machinery spaces housing plant evaporators and condensers are located below the waterline of the bottom-founded structure 112. Warm water intake and discharge ports 140 are formed in bulkheads of the evaporator deck. In the bottom-founded structure 112, the warm water intake and discharge ports 140 are open to the surrounding seawater. In some bottom-founded structures 112, warm intake and/or discharge piping may be required to control the depth of warm water intake or discharge. For example, discharge piping can be used to return water warm discharge at an appropriate depth to avoid thermal contamination of the warm water intake. Cold water ports 142 provide attachments points for the primary seawater pipe 122.

The bottom-founded structure 112 is securely attached to the seabed at a location with a depth D1 between 50 and 250 feet (e.g., less than 200 feet, less than 150 feet, greater than 80 feet, or greater than 100 feet). At these depths, divers can inspect, service, and maintain external connections such as, for example, the ports, flanged pipe connections, and pipe anchor devices. The bottom-founded structure can be configured with the top of the main structure (e.g., the top of the evaporator deck) a depth D3 of between 50 and 250 feet. This places the top of the main structure continuously submerged and beneath aeration of routine wave action potentially reducing corrosion-causing oxidation. This configuration also places the warm water return and cold water intake and return pipe connections well beneath the severe wave affect zone.

The primary seawater pipe 122 can be formed as described in PCT application PCT/US2013/065098 filed on Oct. 15, 2013. However, the bottom-founded structure 112 is fixed in position and the primary seawater pipe 122 is disposed on the sea floor and, optionally, covered with riprap. As the primary seawater pipe 122 experiences little to no stress at the connection to the bottom-founded structure 112, lower cost HDPE for pipes material with up to 100 year service life can be used, Such pipes are commercially available though up to 80 inches in outside diameter from Australia, Germany, USA and Dubai.

The exemplary OTEC plant 100 houses a 4-stage hybrid heat exchange cycle as described in PCT application PCT/US2013/068894 filed Nov. 7, 2013. Other heat exchange cycles and plant configurations can also be used in a bottom-founded OTEC plant.

The main part of the bottom-founded structure 112 is a steel structure 70 feet square with rounded corners made from round pipe to provide strength and stiffening. Some structures are octagonal rather square with rounded corners There is enough space along a single side of this structure to accommodate enough heat exchanger surface area for all four stages, leaving the remaining space on the deck for machinery. For example, the warm water pumps and turbine-generators can go on the upper deck, with the condensers, cold water pumps and ammonia recovery tank and recirculation pump on the lower deck.

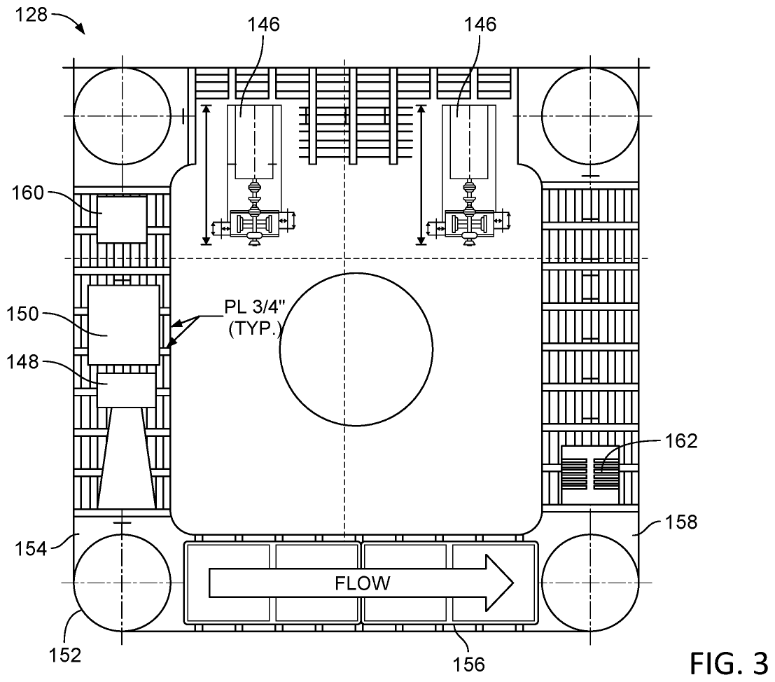

Referring to FIG. 3, the access trunk 132 extends through the center of the evaporator deck 128. Machinery installed on the evaporator deck includes a dual 1.5 megawatt turbo generator set 146, a pump 148, and a pump variable frequency drive 150. Warm water flows from a screened opening in the side of the warm water intake pipe 152 and warm water intake plenum 154 across evaporator heat exchangers 156 to warm water return plenum 158. The warm seawater intake 170 includes a mesh screen (to avoid intake of fish) and has an average inlet velocity of 0.5 feet/second. The mesh screen may have a pore size of approximately 0.5 inches. The warm seawater intake 170 is located at least 10 feet below the mean high tide water level 180 (shown in FIG. 2). The warm flows from the screened intake plenum to the heat exchanger chamber and out through the warm water return plenum. The heat exchangers can be implemented using, for example, the heat exchange plates, cabinets, and systems described in PCT Applications PCT/US2013/065004, filed Oct. 15, 2013, PCT/US2012/050941, filed Aug. 15, 2012, and PCT/US2012/050933, filed Aug. 15, 2012. In contrast to these systems, the heat exchangers in the exemplary bottom-founded OTEC plant 100 are oriented for horizontal rather than vertical flow.

The evaporator deck 128 also includes an escape trunk 160 with a vertical ladder and an escape trunk 162 with an inclined ladder

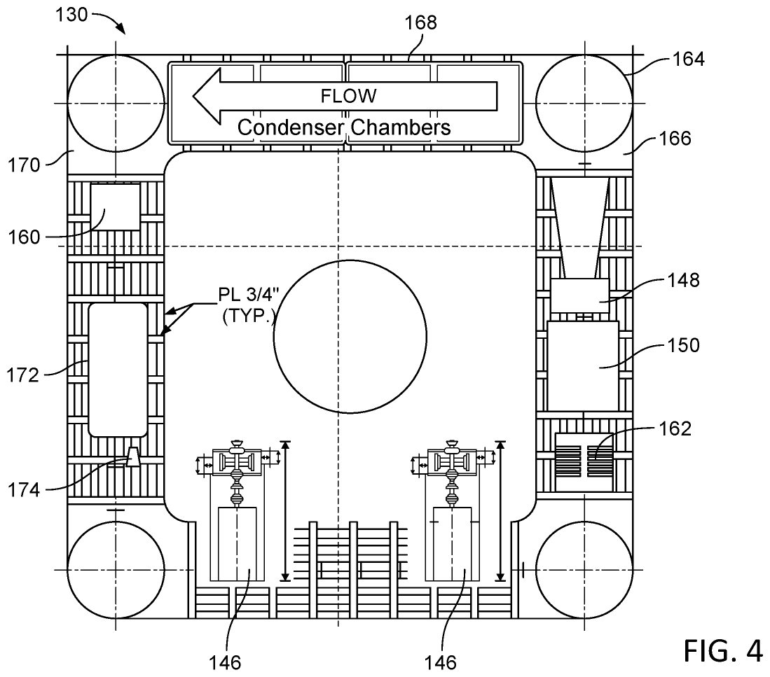

Referring to FIG. 4, the condenser deck includes substantially the same features in a complementarily layout to the evaporator deck. The dual turbo-generators 146 are mounted on the opposite side of the deck from the dual turbo-generators 146 on the deck above. Cold water flows from cold water intake pipe 164 and cold water intake plenum 166 across condenser heat exchangers 168 to cold water return plenum 170. An ammonia recovery tank 172 and ammonia recirculation pump 174 are also located on the condenser deck.

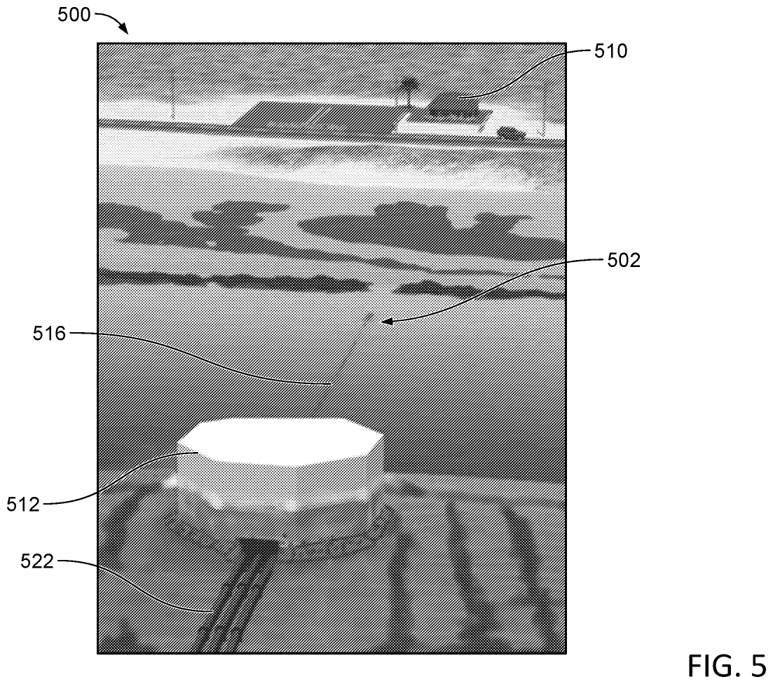

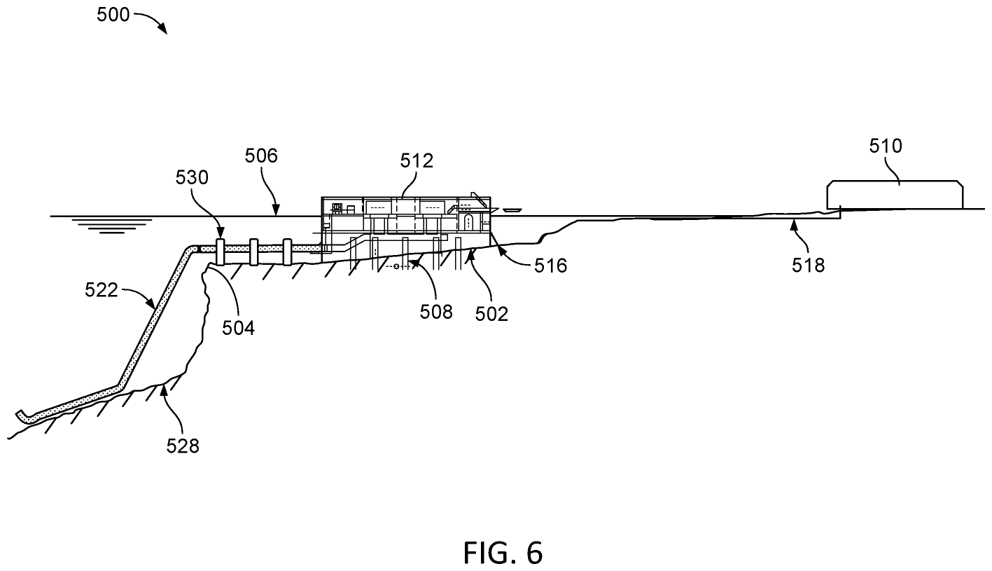

FIG. 5 shows another embodiment of an OTEC plant 500. A bottom-founded structure 512 of the OTEC plant 500 is approximately octagonal in shape and made of steel. The octagonal shape helps to protect the bottom-founded structure 512 from damage from crashing waves during storm conditions. Additionally, waves may crash over the top of the bottom-founded structure 512 during storm conditions without damaging the structure. The bottom-founded structure 512 is configured to withstand storm conditions up to and including a 100-year storm. The OTEC plant 500 includes primary seawater pipes 522 extending from the bottom-founded structure 512 over a shelf break (shown in FIG. 6) to a depth of at least 1500 feet. The primary seawater pipes 522 are disposed on the sea floor. In some examples, one or more of the primary seawater pipes 522 may be used for cold seawater intake while one or more of the other primary seawater pipes 522 is used for discharge. In some examples, cold seawater intake and discharge are provided by a single primary seawater pipe 522 that has at least two separate flow channels.

The OTEC plant 500 also includes transmission lines 516 extending onshore from the bottom-founded structure 512. The transmission lines 516 carry power generated in the bottom-founded structure 512 to an interconnection facility 510 where the power can be delivered to a power grid for distribution. The transmission lines 516 are buried into the sea floor 502 so that they proceed underneath reef structures on the sea floor 502, thereby avoiding possible reef disruption. The transmission lines can be placed to avoid reefs in addition to or instead of being buried. The transmission lines 516 may connect to the interconnection facility 510 from underground. For example, the transmission lines 516 in FIG. 5 are buried underneath a portion of the sea floor 502, a beach, and a road before reaching the interconnection facility 510. Power is delivered at 13.8 kV to 35.0 kV from the bottom-founded structure 512 through the transmission lines 516 to the interconnection facility 510. The power delivered from the bottom-founded structure 512 may be stepped up on shore to 33 kV to 69 kV or higher to be delivered to the power grid. Average annual net power output of the OTEC plant 500 is between approximately 5 and 15 MW.

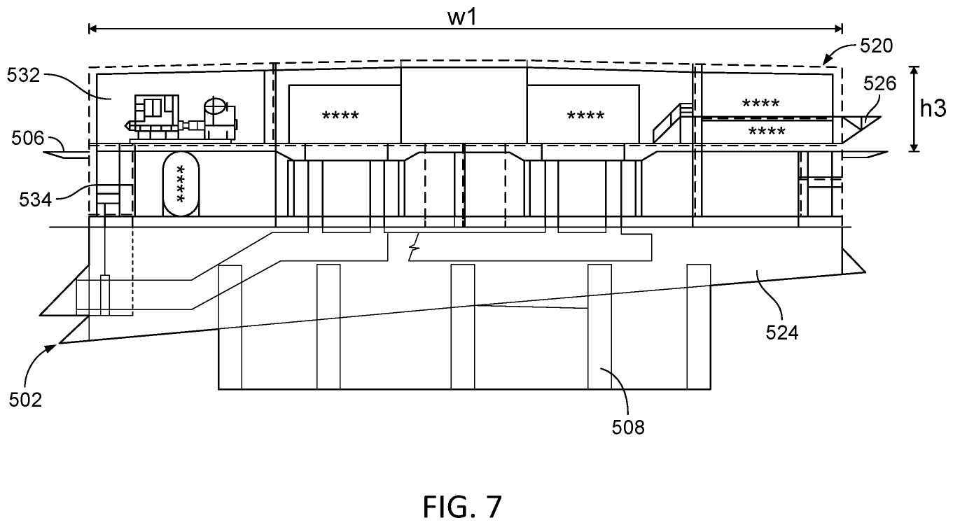

FIG. 6 shows a side view schematic of the OTEC plant 500. The bottom-founded structure 512 is positioned on the sea floor 502 close to a shelf break 504 and extends above a mean high tide water level 506. The bottom-founded structure 512 is positioned in water between approximately 30 and 80 feet deep at mean high tide. The bottom-founded structure 512 is secured to the sea floor 502 by a plurality of pile anchors 508. The pile anchors 508 connect the base 524 (shown in FIG. 7) of the bottom-founded structure 512 down to the dolomite layer below the sea floor 502. The pile anchors 508 may have a diameter of between 16 and 48 inches.

Primary seawater pipes 522 extend from the bottom-founded structure 512, over the shelf break 504, down the wall, and along the sea floor 528 to a depth of at least 1500 feet. The primary seawater pipes are made of high-density polyethylene (HDPE), have an inner diameter of approximately 8 feet, and have an outer diameter of approximately 8.2 feet. Using HDPE pipes is advantageous because HDPE resists attachment by marine life, is nonconductive of electricity, and does not degrade in seawater. The primary seawater pipes 522 are secured to the sea floor 502 and 528 with concrete saddle anchors 530 and pendant anchors 531. The concrete saddle anchors 530 and pendant anchors 531 hold the cold water and warm water pipes in place during storm conditions. The cold water intake pipes 522 are configured to deliver cold seawater to the bottom-founded structure 512 at a temperature of approximately 40° F. The cold water return pipe 523 discharges used cold water at a depth near or below the mixing layer approximately 100 to 160 yards deep. The warm water return pipe 521 discharges used warm water at the same depth as and next to the cold water return pipe 523 so that the two flows mix and rapidly assimilate with the ambient ocean conditions.

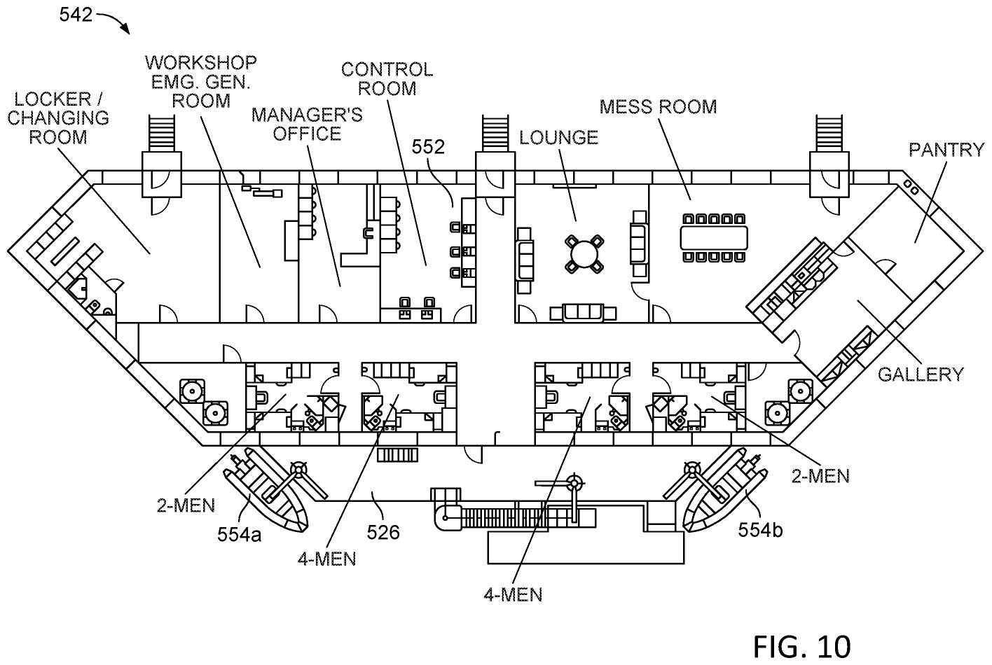

Unlike the unmanned bottom-founded structure 112 of the OTEC plant 100 of FIGS. 1-4, the bottom-founded structure 512 is operated by a crew within the bottom-founded structure 512. As shown in FIG. 7, the bottom-founded structure 512 includes a first deck 532, a second deck 534, and a base 536. The base 536 is anchored to the sea floor by the plurality of pile anchors 508. The first deck 532 and the second deck 534 house power generation equipment, a control room 552 (shown in FIG. 10), and living quarters for the crew of the OTEC plant 500. The first deck 532 extends above the mean high tide water level while the second deck 534 lies below sea level. The first deck 532 connects to a platform 526 on the exterior of the bottom-founded structure 512. Multiple small boats may be secured to the platform 526. The small boats provide the crew living and working in the bottom-founded structure 512 access to the shore.

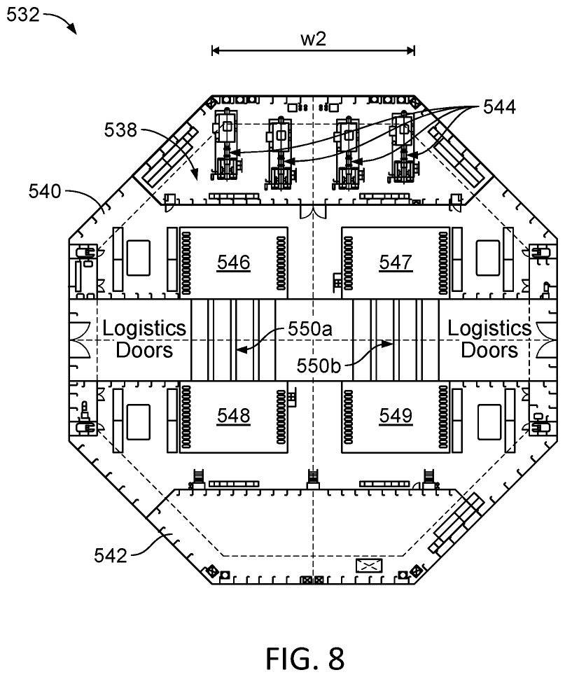

The first deck 532 extends a height h3, which may be between approximately 18 and 30 feet, above the mean high tide water level 506. The bottom-founded structure 512 has a width w1, which is approximately 180-240 feet. Each side of the octagonal-shaped bottom-founded structure 512, shown in FIG. 8 as w2, is approximately 80 to 95 feet long. A top 520 of the bottom-founded structure 512 is cambered allowing for drainage and for waves to more easily crash over the bottom-founded structure 512 during storm conditions.

FIG. 8 shows a schematic of the first deck 532 of the bottom-founded structure 512. The first deck 532 is split into three zones: an upper ammonia zone 538, an upper main zone 540, and a crew zone 542. The first deck 532 is approximately 2 feet above the mean high tide water surface 506. The upper ammonia zone 538 includes turbine generators 544 configured to generate electrical power. The upper ammonia zone 538 is located on an ocean-facing side of the bottom-founded structure 512 such that ammonia is located as far from shore as possible. Additionally, noise emission to the shore from the turbine generators 544 is reduced. The upper ammonia zone 538 is separated from the upper main zone 540 by air-lock entries.

The crew zone 542 is located on the shore-facing side of the bottom-founded structure 512. The crew zone 542 is set atop a raised deck so that a cofferdam exists between the machinery spaces of the first and second decks 532, 534 and the crew zone 542. The cofferdam serves to raise the crew zone 542 above the upper ammonia zone 538 and the main zone 540. Therefore, any water that may be on the deck of the main zone 540 is below the level of the crew zone. The main zone 540 is outfitted with ammonia sensors and ventilated to maintain a lower pressure than the crew zone 542 above so that no ammonia gas, should a leak occur, will enter the crew zone 542.

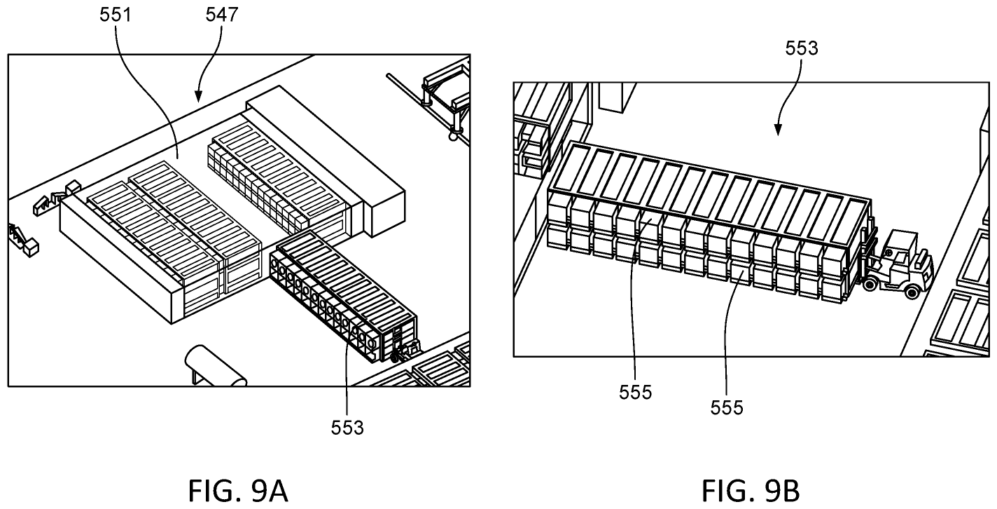

The upper main zone 540 includes condensing heat exchangers 546, 547 and evaporating heat exchangers 548, 549 in which the ammonia is cooled and heated, respectively. As shown in FIGS. 9A and 9B for heat exchanger 547, each heat exchanger 546-549 includes an outer heat exchanger enclosure 551 which provides physical protection from the upper main zone 540. The outer heat exchanger enclosure 551 also and provides a flow path for cold and/or warm seawater to flow. Each heat exchanger 546-549 also includes four to twenty racks 553. Each rack is configured to hold multiple arrays 555. Each array is approximately 10 feet long, 29 inches high, and 28 inches wide. The arrays can be used interchangeably in both the condensing heat exchangers 546, 547 and the evaporating heat exchangers 548, 549. Each array holds multiple cartridges. Ammonia flows through the cartridges during operation of the OTEC plant 500. When a heat exchanger is not in operation, the outer heat exchanger enclosure 551 can be opened and one or more racks 553 can be removed for maintenance. The racks 553 can be pulled out of the heat exchangers 546-549 on tracks 550a-b (shown in FIG. 8).

FIG. 10 shows crew zone 542 which includes space for controlling the machinery of the OTEC plant 500 and space for the crew to live and recreate. The crew running the OTEC plant 500 includes approximately seventeen members, with a minimum of six members being present on the bottom-founded structure 512 at any given time. The control room 552 overlooks the upper main zone 540 and includes equipment for monitoring and controlling flows through the heat exchangers 546-549 and other machinery of the bottom-founded structure 512 as well as power conditioning and transfer to the onshore interconnection facility 510. Equipment on the second deck 534 may also be controlled from the control room. The crew zone 542 also provides access to the exterior of the bottom-founded structure 512 onto platform 526. The platform 526 allows for small boats 554a-b to be docked at the bottom-founded structure 512. The boats 554a-b provide access to the shore to the crew for normal operations or in emergency evacuation protocols.

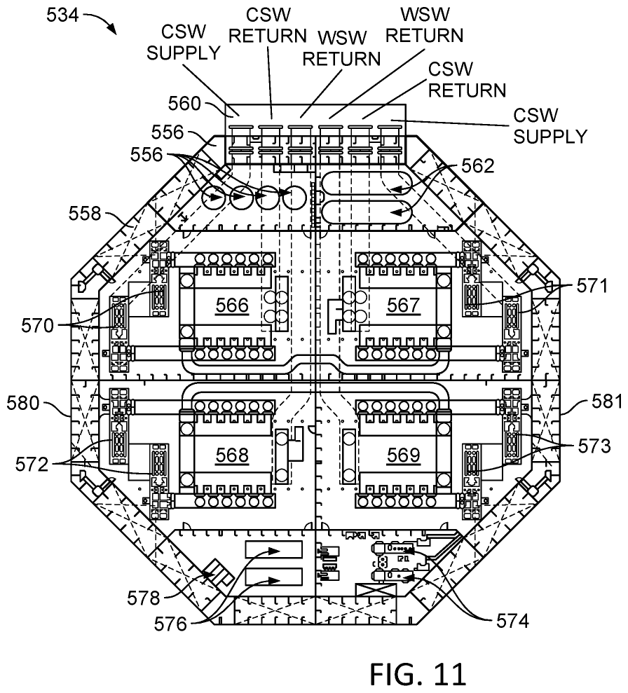

FIG. 11 shows the second deck 534 which includes three zones, a lower ammonia zone 556, a lower main zone 558, and a water supply/return zone 560. The lower ammonia zone 556 includes ammonia storage tanks 562 and ammonia collection tanks 564. Approximately 8,000 gallons of ammonia is stored in the ammonia storage tanks 562 during operation and approximately 40,000 gallons of ammonia is in use during operation.

The second deck 534 includes seawater intakes for both the cold and warm seawater. The cold water intakes (“CSW supply”) are located in the water supply/return zone 560 whereas the warm seawater intakes 580, 581 are located in the sides of the bottom-founded structure 512. The warm seawater intakes 580, 581 include a plenum including a mesh screen (to avoid intake of fish) and has an average inlet velocity of 0.5 feet/second or less. The mesh screen may have a pore size of approximately 0.5 inches. The warm seawater intakes 580, 581 are located at least 10 feet below the mean high tide water level 506 (shown in FIG. 7). The lower main zone 558 includes cold seawater strainers 566, 567 and warm seawater strainers 568, 569 that strain the cold seawater and warm seawater, respectively, to remove debris prior to pumping the seawater through the heat exchangers 546-549. Cold seawater pumps 570 and 571 pump strained cold seawater into the heat exchangers 546 and 547, respectively. Warm seawater pumps 572 and 573 pump strained warm seawater into the heat exchangers 548 and 549, respectively.

Startup generators 574 are located on the shore-facing side of the bottom-founded structure 512. The startup generators 574 may be, for example, 2.0 MW diesel generators, and are used when beginning a power generation process. After the bottom-founded structure 512 is generating enough power to power itself during the power generation process, the startup generators 574 may be turned off. Housing the seawater pumps 570-573 and the startup generators 574 on the second deck 534, which is below the mean high tide water level 506, limits air-borne noise emissions from the bottom-founded structure 512. Step up transformers 576 are also located on the shore-facing side of the bottom-founded structure 512. The step up transformers 576 increase the voltage of the electrical power produced at the turbines 544 for transmission to shore. A disconnect 578 is located near to the step up transformers 576 on the second deck 534. The disconnect 578 disconnects the power generation system of the bottom-founded structure 512 from the transmission lines 516.

To start power generation by the OTEC plant 500, the startup generators 574 are turned on to power the seawater pumps 570-573 to pull seawater into the bottom-founded structure 512 and begin the heat exchange process between the seawater and the ammonia. When ammonia gas begins to turn the turbine generators 544 at a level to produce sufficient electrical power to power the bottom-founded structure 512, the startup generators 574 may be turned off. The startup generators 574 can be quickly restarted upon receipt of a demand signal from the operations center on shore to provide operating reserve and quick-load pickup to the utility grid.

In operation, the bottom-founded structure 512 produces electric power from streams of seawater at cold and warm temperatures. Warm seawater is pumped into the bottom-founded structure 512 via warm water intakes 580, 581 from an area near the surface proximate to the bottom-founded structure 512. The warm seawater is at a temperature of approximately 78 to 86° F. and is pulled from a depth of about 24 to 40 feet below the surface. The warm water is strained at strainers 568-569 and pumped through evaporating heat exchangers 548-549. In the evaporating heat exchangers 548-549, heat transfers from the warm seawater to liquid ammonia present in the cartridges of the evaporating heat exchanger 548-549. The ammonia, receiving the heat, changes phase from a liquid to a gas. The gaseous ammonia is routed to and turns four turbine generators 544 to produce electrical energy. Electrical energy from the turbine generators 544 is used to power the bottom-founded structure 512 (e.g., onboard pump motors, electrical equipment, communication and control systems, lights and appliances). The balance of the electrical energy produced in the bottom-founded structure 512 is transmitted to the onshore interconnection facility 510 via transmission lines 516.

After the ammonia gas leaves the turbine generators 544, the ammonia gas flows into cartridges in the condensing heat exchangers 546-547. Cold seawater, at a temperature of about 40° F., is pumped from deep in the ocean through primary seawater pipes 522, strained at strainers 566-567, and pumped into the condensing heat exchangers 546-547. The cold seawater chills the gaseous ammonia and the ammonia transitions from a gas back into a liquid. The liquid ammonia is collected in tanks beneath the condensing heat exchangers 546-547 to be pumped back into the evaporating heat exchangers 548-549 to continue the process in a closed loop. Therefore, the ammonia, as the working fluid, is never intentionally released into the air or water.

The bottom-founded structure 512 uses multiple pumps 570-573 so that maintenance can be performed on one of the pumps 570-573 with minimum reduction of net power output. The seawater pumps 570-573 operate continuously at a combined rate of 200,000 gpm to 500,000 gpm of warm surface ocean water and 170,000 gpm to 410,000 gpm of cold deep ocean water. Turbine-generators 544 are connected so that any of the heat exchangers 546-549 or turbine-generators 544 can be isolated and taken off-line for servicing without disrupting remaining plant operation.

The cycle of evaporating and condensing the ammonia to produce electrical energy is monitored from a control room 552 in the crew zone 542 of the first deck 532. The crew zone 542 of the first deck 532 can be accessed from the upper main zone 540 on the first deck 532 via stairs. Many mechanical and electrical components of the power generation system in the bottom-founded structure 512 include sensors, video monitors, controls, and alarms which feed into a central control panel in the control room 552. Communication is available between the control room 552 and key machinery spaces on the first deck 532 and the second deck 534. Communication is also available between the bottom-founded structure 512 and the interconnection facility 510 on shore.

Emergency systems to address fire, leakage, etc. are included in the control protocols for the bottom-founded structure 512. In the unlikely event of an ammonia leak in any space within the bottom-founded structure 512, sensors will detect the leak, sound an alarm, and if the danger is above a prescribed level, a medium-pressure water mist system will be activated. Ammonia has a very high affinity for water, and the aqueous ammonia solution produced from the water mist mixing with the ammonia will be collected in a segregated gravity drain collection system. The water is checked for environmental compliance, treated as necessary, and then discharged.

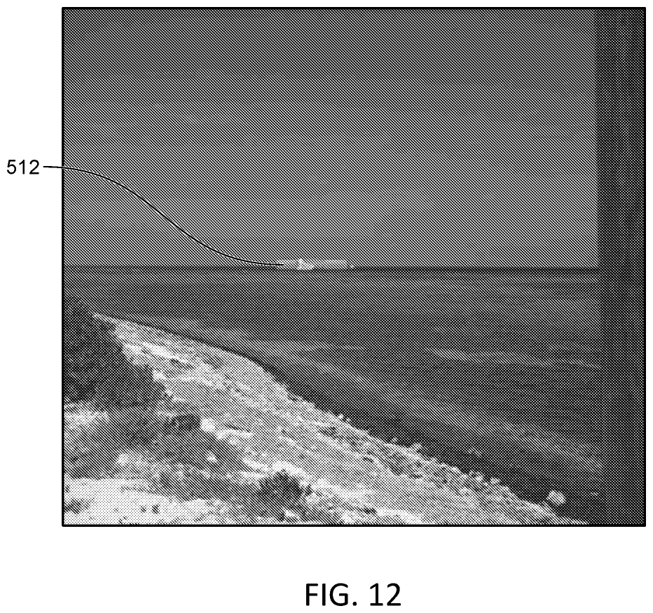

FIG. 12 shows the bottom-founded structure 512 of FIG. 5 as seen from shore. The bottom-founded structure 512 may be painted to match the ocean and/or sky to limit the visual impact of the structure from shore. The octagonal shape of the bottom-founded structure 512 with a squared shoreline smooths the visual profile of the bottom-founded structure 512.

All references mentioned herein are incorporated by reference in their entirety.

Other embodiments are within the scope of the following claims. For example, some OTEC plants also include waterlines extending onshore from the bottom-founded structure 112. Such waterlines can be used to provide cold sea water to onshore facilities for cooling. The cold water can be diverted before or after the cold water passes through condensers in the bottom-founded structure 112.

Some heat exchanger cabinets are arranged such that two racks are stacked per stage (four arrays high). In some heat exchangers, the lengths of the sides may be reduced because the chambers are not as deep, taking up less footprint. A reduced side length may also reduce loading due to waves from passing (mega-PANAMAX) cargo carriers and from tsunamis. The pumps may also be arranged farther (deeper) below the waterline in the dry machinery space.

Some OTEC plants use a 3000 mm diameter high-density polyethylene (HDPE) pipe. The 3000 mm diameter pipe reduces pumping parasitic load and/or expansion of flow such that only one set of pipes rather than two sets of pipes. Some OTEC plants use micro-piles rather than a standard 36″ to 60″ diameter piles. Micro-piles can be installed or used by local contractors thereby increasing the speed of installation and reducing the cost of installation.

What is claimed:

1. An ocean thermal energy conversion plant comprising:
an operations center located onshore;
a bottom-founded structure located offshore, the bottom-founded structure containing plant evaporators and plant condensers; and
a control system extending between the operations center and plant machinery in the bottom-founded structure.

2. The ocean thermal energy conversion plant of claim 1, comprising a primary seawater pipe extending from the bottom-founded structure to a depth of at least 1500 feet, the primary seawater pipe disposed on the seabed.

3. The ocean thermal energy conversion plant of claim 1, comprising transmission lines extending from the bottom-founded structure across a shoreline, the transmission lines configured to transmit between 10 kilovolts and 35 kilovolts of electricity.

4. The ocean thermal energy conversion plant of claim 1, comprising waterlines extending onshore from the bottom-founded structure.

5. The ocean thermal energy conversion plant of claim 1, wherein the control system comprises control cables extending between the operations center and the bottom-founded structure.

6. The ocean thermal energy conversion plant of claim 1, wherein the plant evaporators and the plant condensers are located below the waterline of the bottom-founded structure.

7. The ocean thermal energy conversion plant of claim 1, wherein the bottom-founded structure extends less than 30 feet above the waterline.

8. The ocean thermal energy conversion plant of claim 1, wherein the bottom-founded structure has a vertical height measured from the seabed to a highest overhead and highest overhead of the bottom-founded structure extends above the waterline less than 20% of the vertical height of the bottom-founded structure.

9. The ocean thermal energy conversion plant of claim 1, wherein the bottom-founded structure is placed at a location within water depth of between 50 and 250 feet (e.g., less than 200 feet, less than 150 feet, greater than 80 feet, or greater than 100 feet).

10. The ocean thermal energy conversion plant of claim 1, wherein the bottom-founded structure is placed at a location where the distance between the shoreline and shelf break is between 150 yards and 6600 yards.

11. The ocean thermal energy conversion plant of claim 10, wherein the bottom-founded structure is placed at a location where the seabed offshore of the shelf break descends to a depth of at least 1500 feet within 8000 yards of the shoreline.

12. A method of providing electricity, the method comprising:
transmitting signals from a operations center located onshore to an unmanned structure located offshore; and
operating evaporators, condensers, and pumps located in the unmanned or manned structure in response to the signals to generate between 0.5 megawatts and 15 megawatts of electricity in the unmanned structure.

13. The method of claim 12, comprising pumping seawater from a depth of at least 1500 feet to the unmanned structure.

14. The method of claim 12, comprising transmitting electricity onshore from the unmanned structure.

15. The method of claim 12, comprising pumping water onshore from the unmanned structure.

16. The method of claim 12, wherein transmitting signals comprises transmitting signals from the operations center to the unmanned structure through control cables extending between the operations center and the bottom-founded structure.

17. An ocean thermal energy conversion plant comprising:
a bottom-founded structure located offshore, the bottom-founded structure containing evaporating heat exchangers, condensing heat exchangers and a control center; and
transmission lines extending from the bottom-founded structure across a shoreline to an onshore interconnection facility.

18. The ocean thermal energy conversion plant of claim 17, comprising a primary seawater pipe extending from the bottom-founded structure to a depth of at least 1500 feet, the primary seawater pipe disposed on the seabed.

19. The ocean thermal energy conversion plant of claim 17, wherein the bottom-founded structure has an approximately octagonal shape when viewed from above.

20. The ocean thermal energy conversion plant of claim 17, wherein the bottom-founded structure has a first deck located above the mean high tide water level and a second deck located below the mean high tide water level.

21. The ocean thermal energy conversion plant of claim 20, wherein the condensing heat exchangers and the evaporating heat exchangers are located on the first deck.

22. The ocean thermal energy conversion plant of claim 20, comprising pumps configured to pump cold seawater and warm seawater through supply and return pipes, wherein the pumps are located on the second deck.

23. The ocean thermal energy conversion plant of claim 17, wherein the transmission lines are configured to transmit approximately 10 kilovolts to 35 kilovolts of electricity to the onshore interconnection facility.

24. The ocean thermal energy conversion plant of claim 17, wherein the bottom-founded structure extends less than 30 feet above the mean high tide water level.

25. The ocean thermal energy conversion plant of claim 17, wherein the bottom-founded structure has a vertical height measured from the sea floor to a highest overhead and the highest overhead of the bottom-founded structure extends above the mean high tide water level less than 40% of the vertical height of the bottom-founded structure.

26. The ocean thermal energy conversion plant of claim 17, wherein the bottom-founded structure includes accommodations for a crew.

27. The ocean thermal energy conversion plant of claim 17, wherein the bottom-founded structure is approximately three times as wide as it is tall.

28. The ocean thermal energy conversion plant of claim 17, wherein the condensing heat exchangers and the evaporating heat exchangers are modular.

29. The ocean thermal energy conversion plant of claim 17, wherein the bottom-founded structure is placed at a location within water depths of between 30 and 180 feet.

30. A method of providing electricity, the method comprising:
transmitting control signals from a control room of a bottom-founded structure;
operating evaporating heat exchangers, condensing heat exchangers, and pumps located in the bottom-founded structure in response to the signals to generate between 0.5 megawatts and 15 megawatts of electricity in the bottom-founded structure; and
transmitting electricity to an onshore interconnection facility via transmission lines.

31. The method of claim 30, comprising pumping seawater from a depth of at least 1500 feet to the bottom-founded structure.

32. The method of claim 30, wherein approximately 10 kilovolts to 35 kilovolts of electricity is transmitted to the onshore interconnection facility.
